(19) United States
(12) Patent Application Publication
(10) Pub. No.: US 2018/0150231 A1
(43) Pub. Date: May 31, 2018

(54) DATA MANAGEMENT DEVICE, DATA MANAGEMENT METHOD, AND ROBOT SYSTEM

(71) Applicant: Seiko Epson Corporation, Tokyo (JP)

(72) Inventor: Yuzo HANYU, Fujimi (JP)

(21) Appl. No.: 15/823,972

(22) Filed: Nov. 28, 2017

(30) Foreign Application Priority Data
Nov. 30, 2016 (JP) 2016-232188

(51) Int. Cl. G06F 3/06; G06F 9/44; G06F 3/0482

(52) U.S. Cl. CPC G06F 3/0605; G06F 3/0643; G06F 3/0482; G06F 3/0614; G06F 9/4443; G06F 3/0653

(57) ABSTRACT

A data management device includes: a storage unit which saves data; a display unit which displays information based on data saved in the storage unit; an input unit for inputting an instruction on whether to save data in the storage unit or not, if a free space in the storage unit is less than a preset capacity lower limit value before data is saved in the storage unit; and a data management unit which manages whether to save data in the storage unit or not, based on the instruction.

### BACKGROUND

### 1. Technical Field

The present invention relates to a data management device, a data management method, and a robot system.

### 2. Related Art

Traditionally, a device which has the function of saving log data is at risk of stopping its operation if an error occurs due to a shortage of capacity at a data save location. Also, in some cases, processing at the time of a shortage of capacity may be fixed and different from the user's intention, and therefore intended log data may not be able to be saved over a long period, though the stoppage of the device can be avoided.

In contrast, a data management device is disclosed which detects the free space in a hard disk device, calculates the data volume that can be saved based on the free space, displays the data volume that can be saved on a display, transfers data saved in the hard disk device to an optical disk device, based on an instruction from the user, and secures a free space to newly save data in the hard disk device (see, for example, JP-A-2001-306366).

JP-A-2001-306366, the function of managing the free space at the save location at the time of saving log data is not sufficient and there is a risk of stoppage of the device and loss of log data in the case of continuous operation.

### SUMMARY

An advantage of some aspects of the invention is to solve at least a part of the problems described above, and the invention can be implemented as the following forms or application examples.

### Application Example 1

A data management device according to this application example includes: a storage unit which saves data; a display unit which displays information based on data saved in the storage unit; an input unit for inputting an instruction on whether to save data in the storage unit or not, if a free space in the storage unit is less than a preset capacity lower limit value before data is saved in the storage unit; and a data management unit which manages whether to save data in the storage unit or not, based on the instruction.

According to this application example, whether to save data in the storage unit or not is managed, based on an instruction from the user. Therefore, the saving of data as intended by the user can be realized while the risk of operation stoppage of the device is reduced. Thus, the stoppage of the device caused by data saving failure due to a shortage of capacity can be avoided. As a result, a data management device which maintains continuous operation can be provided.

### Application Example 2

In the data management device according to the application example, it is preferable that the instruction is not to save data in the storage unit if the free space is less than the capacity lower limit value.

According to this application example, the user can easily realize the saving of data as intended.

### Application Example 3

In the data management device according to the application example, it is preferable that the instruction is to save data in the storage unit after data saved in the storage unit is deleted if the free space is less than the capacity lower limit value.

According to this application example, the user can easily realize the saving of data as intended.

### Application Example 4

In the data management device according to the application example, it is preferable that the data management unit includes: a data acceptance unit which accepts data; a free space detection unit which detects the free space in the storage unit; a free space notification unit which causes the display unit to display an instruction that can be selected by a user; and a saving method instruction acceptance unit which accepts, from the user, an instruction on whether to save data in the storage unit or not, if the free space in the storage unit is less than a preset capacity lower limit value before data is saved in the storage unit.

According to this application example, the user can easily realize the saving of data as intended.

### Application Example 5

In the data management device according to the application example, it is preferable that the data management unit has a capacity lower limit value instruction acceptance unit which accepts the capacity lower limit value before data is saved in the storage unit.

According to this application example, the user can easily realize the saving of data as intended.

### Application Example 6

A data management method according to this application example includes: saving data in a storage unit; displaying information based on data saved in the storage unit; inputting an instruction on whether to save data in the storage unit or not, if a free space in the storage unit is less than a preset capacity lower limit value before data is saved in the storage unit; and managing whether to save data in the storage unit or not, based on the instruction.

According to this application example, whether to save data in the storage unit or not is managed, based on an instruction from the user. Therefore, the saving of data as intended by the user can be realized while the risk of operation stoppage of the device is reduced. Thus, the stoppage of the device caused by data saving failure due to a shortage of capacity can be avoided. As a result, a data management method which maintains continuous operation can be provided.

### Application Example 7

A program according to this application example causes a computer to function as: a data acceptance unit which accepts data; a free space detection unit which detects a free space in a storage unit; a free space notification unit which causes a display unit to display an instruction that can be selected by a user; and a saving method instruction acceptance unit which accepts, from the user, an instruction on whether to save data in the storage unit or not, if the free space in the storage unit is less than a preset capacity lower limit value before data is saved in the storage unit.

According to this application example, whether to save data in the storage unit or not is managed, based on an instruction from the user. Therefore, the saving of data as intended by the user can be realized while the risk of operation stoppage of the device is reduced. Thus, the stoppage of the device caused by data saving failure due to a shortage of capacity can be avoided. As a result, a program which maintains continuous operation can be provided.

### Application Example 8

A robot system according to this application example comprises the data management device according to one of the foregoing application examples.

According to this application example, whether to save data in the storage unit or not is managed, based on an instruction from the user. Therefore, the saving of data as intended by the user can be realized while the risk of operation stoppage of the device is reduced. Thus, the stoppage of the device caused by data saving failure due to a shortage of capacity can be avoided. As a result, a robot system which maintains continuous operation can be provided.

### BRIEF DESCRIPTION OF THE DRAWINGS

The invention will be described with the accompanying drawings, wherein like numbers reference like elements.

FIG. 1 is a configuration view showing an example of an image processing system according to an embodiment.

FIG. 2 shows an example of the hardware configuration of an image processing device.

FIG. 3 shows an example of the functional configuration of the image processing device.

FIG. 4 shows an example of an option screen.

FIG. 5 shows an example of a log data setting screen.

FIG. 6 shows an example of an image log setting screen.

FIG. 7 shows an example of a capacity management screen.

FIG. 8 shows results of saving in the case where the free space is less than a capacity lower limit value.

FIG. 9 shows an example of a display on a user interface.

FIG. 10 is a flowchart showing an example of a flow of inputting an instruction.

FIG. 11 is a flowchart showing an example of a data management method.

FIG. 12 is a flowchart showing an example of a flow of “processing of user instruction”.

FIG. 13 is a flowchart showing an example of a flow of “processing of not managing”.

FIG. 14 is a flowchart showing an example of a flow of “processing of not saving if the free space is less than the capacity lower limit value”.

FIG. 15 is a flowchart showing an example of a flow of “processing of deleting and saving if the free space is less than the capacity lower limit value”.

FIG. 16 shows an example of the configuration of a robot system according to an embodiment.

### DESCRIPTION OF EXEMPLARY EMBODIMENTS

Hereinafter, a specific embodiment of the invention will be described with reference to the drawings. In the drawings used here, parts to be explained are enlarged or reduced where appropriate, so as to be recognizable.

An image processing device 6 as a data management device according to this embodiment receives a command from an upper controller, not illustrated, then performs image pickup and processing, and returns the result to the upper controller. The image processing device 6 independently has the function of saving log data as data, and an image log. This embodiment relates to the management of saving capacity in the case where the image processing device 6 saves log data and an image log.

### Configuration of Image Processing System

First, the configuration of an image processing system 4 will be described.

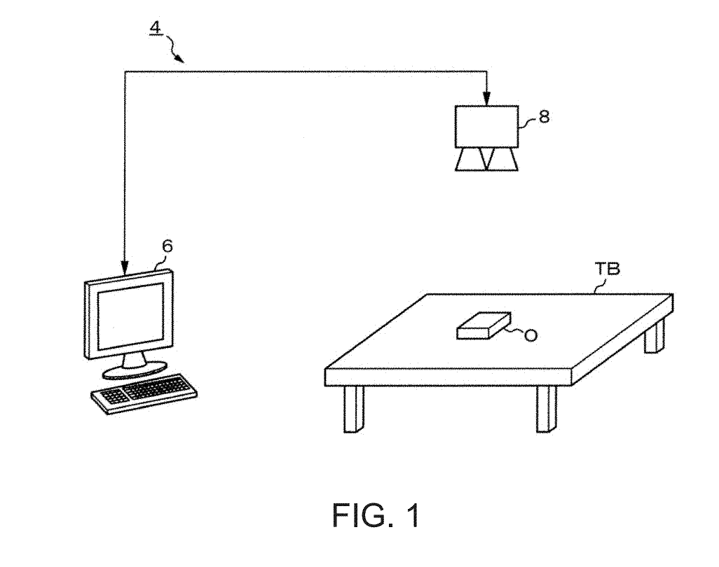

FIG. 1 is a configuration view showing an example of the image processing system 4 according to the embodiment.

The image processing system 4 according to the embodiment has the image processing device 6 and an image pickup unit 8.

The image pickup unit 8 is, for example, a stereo camera having a CCD (charge coupled device) or CMOS (complementary metal-oxide semiconductor) or the like as an image pickup element which converts condensed light into an electrical signal. The image pickup unit 8 may be other cameras capable of picking up a three-dimensional image, such as a light-field camera, instead of the stereo camera. In this example, the image pickup unit 8 is installed at a position where the image pickup unit 8 can pick up an image over a range including an object O.

The object O is, for example, an industrial part or member such as a plate, gear, screw or bolt to be assembled onto a product. In FIG. 1, in order to simplify the illustration, the object O is shown as an object in the shape of a rectangular parallelepiped. The object O may be other objects such as a product for daily use or living body, instead of the industrial part or member. Also, the shape of the object O may be other shapes instead of the rectangular parallelepiped.

In this example, the object O is placed on the top surface of a workbench TB. The workbench TB is, for example, a table. The workbench TB may be other objects where the object O can be placed, such as a floor surface or shelf, instead of the table. In the example shown in FIG. 1, only one object O is placed on the top surface of the workbench TB. However, instead of this, two or more objects O may be placed.

The image pickup unit 8 is connected to the image processing device 6 via a cable in such a way as to be able to communicate. The wired communication via the cable is carried out, for example, according to a standard such as Ethernet (trademark registered) or USB. The image pickup unit 8 may be configured to be connected to the image processing device 6 via wireless communication carried out according to a communication standard such as Wi-Fi (trademark registered).

The image processing device 6 is, for example, a workstation, desktop PC (personal computer), notebook PC, tablet PC, multi-function mobile phone terminal (smartphone), electronic book reader with a communication function, PDA (personal digital assistant) or the like.

The image processing device 6 acquires, from the image pickup unit 8, an image picked up by the image pickup unit 8. The image processing device 6 carries out processing such as inspection and measurement of an object included in the acquired image (for example, the object O shown in FIG. 1). This measurement includes calculating the position and attitude of the object on a three-dimensional coordinate system. The three-dimensional coordinate system is, for example, a three-dimensional local coordinate system such as a three-dimensional world coordinate system WC or three-dimensional robot coordinate system RC. Moreover, this measurement includes calculating the position and distance of the object on a two-dimensional coordinate system. The two-dimensional coordinate system is, for example, a two-dimensional coordinate system expressed by the X-axis and the Y-axis on the world coordinate system WC, a two-dimensional coordinate system expressed by the X-axis and the Y-axis on the robot coordinate system RC, or the like.

### Hardware Configuration of Image Processing Device

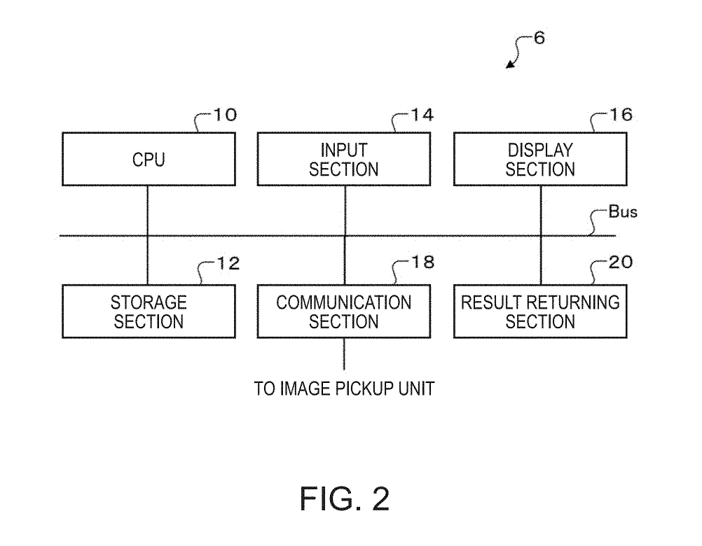

Hereinafter, the hardware configuration of the image processing device 6 will be described with reference to FIG. 2.

FIG. 2 shows an example of the hardware configuration of the image processing device 6. The image processing device 6 has, for example, a CPU (central processing unit) 10, a storage section 12 as a storage unit, an input section 14 as an input unit, a display section 16 as a display unit, a communication section 18, and a result returning section 20. These components are connected to each other via a bus in such away as to be able to communicate. Also, the image processing device 6 communicates with the image pickup unit 8 via the communication section 18.

The CPU 10 executes various programs stored in the storage section 12.

The storage section 12 includes, for example, a HDD (hard disk drive), SSD (solid state drive), EEPROM (electrically erasable programmable read-only memory), ROM (read-only memory), RAM (random access memory) or the like. The storage section 12 may be an external storage device connected via a USB digital input/output port or the like, instead of being built in the image processing device 6. The storage section 12 stores various kinds of information, images and programs processed by the image processing device 6. The storage section 12 saves log data and an image log.

With the input section 14, the user inputs an instruction on whether to save log data and an image log in the storage section 12 or not, if the free space in the storage section 12 becomes less than a preset capacity lower limit value. The input of the instruction by the user is carried out before log data and an image log are saved in the storage section 12. The input section 14 is, for example, a keyboard, mouse, touch pad, or other input devices. The input section 14 may be configured as a touch panel integrated with the display section 16.

The display section 16 displays the result of image processing on a screen after a saving operation in the image processing device 6 is finished. The display section 16 displays information based on the log data and the image log saved in the storage section 12. The display section 16 also receives and displays information about free space from a free space detection section 28 of a data management section 24, described later. The display section 16 is, for example, a liquid crystal display panel or organic EL (electroluminescent) display panel.

The communication section 18 receives an image pickup command from an upper controller and instructs the image pickup unit 8 to pick up an image. The communication section 18 causes the image pickup unit 8 to pick up an image over a range including the object O. The communication section 18 includes, for example, a USB digital input/output port or Ethernet (trademark registered) port or the like.

The result returning section 20 transmits information based on the log data and the image log saved in the storage section 12, to the upper controller. After the operation of saving the log data and the image log is finished, the result returning section 20 transmits the result of the saving to the upper controller. The result returning section 20 receives the result of operation of a data saving section 34, described later, from a saving result notification section 38, described later.

### Functional Configuration of Image Processing Device

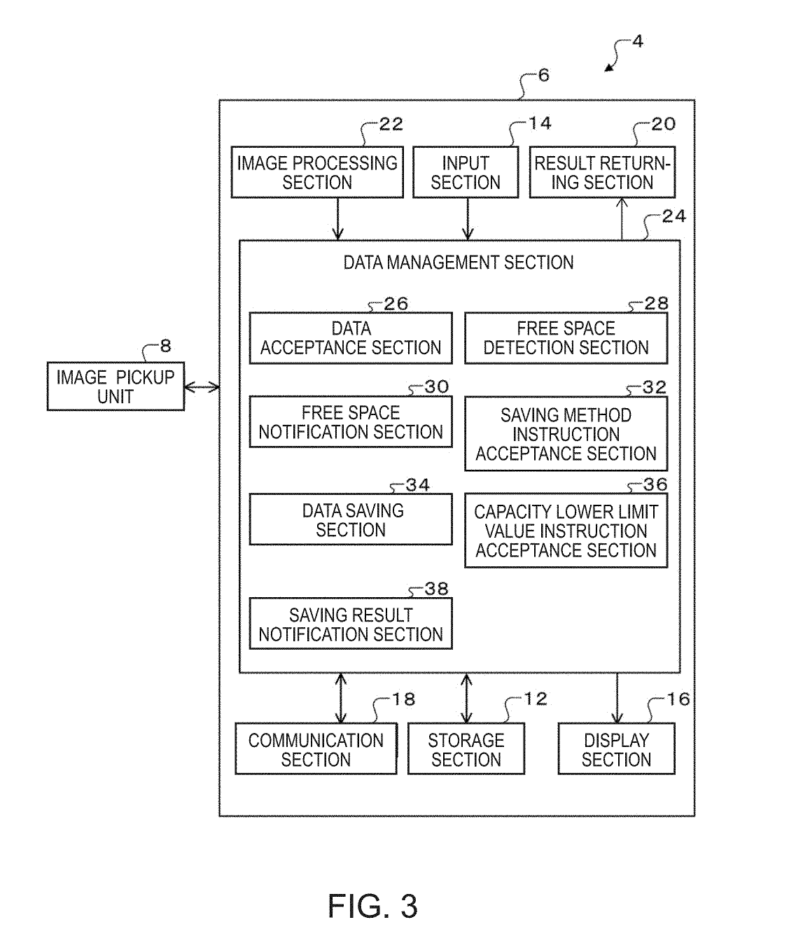

Hereinafter, the functional configuration of the image processing device 6 will be described with reference to FIG. 3.

FIG. 3 shows an example of the functional configuration of the image processing device 6. The image processing device 6 has an image processing section 22, a data management section 24 as data management unit, the storage section 12, the input section 14, the display section 16, the communication section 18, and the result returning section 20.

The image processing section 22 acquires, from the image pickup unit 8, a picked-up image picked up by the image pickup unit 8. The image processing section 22 performs processing with a preset content on the image sent from the image pickup unit 8, and sends log data and an image log to the data management section 24.

The data management section 24 manages whether to save the log data and the image log in the storage section 12 or not, based on an instruction from the user.

The data management section 24 has a data acceptance section 26 as a data acceptance unit, a free space detection section 28 as a free space detection unit, a free space notification section 30 as a free space notification unit, a saving method instruction acceptance section 32 as a saving method instruction acceptance unit, a data saving section 34, a capacity lower limit value instruction acceptance section 36 as a capacity lower limit value instruction acceptance unit, and a saving result notification section 38.

These functional sections provided in the data management section 24 are realized, for example, by the CPU 10 executing various programs stored in the storage section 12. Apart or all of these functional sections may be hardware functional sections such as LSI (large-scale integration) or ASIC (application specific integrated circuit).

The data acceptance section 26 accepts log data and an image log sent from the image processing section 22. The data acceptance section 26 sends the accepted log data and image log to the data saving section 34.

The free space detection section 28 detects the free space in the storage section 12. The free space detection section 28 notifies the data saving section 34 of the free space.

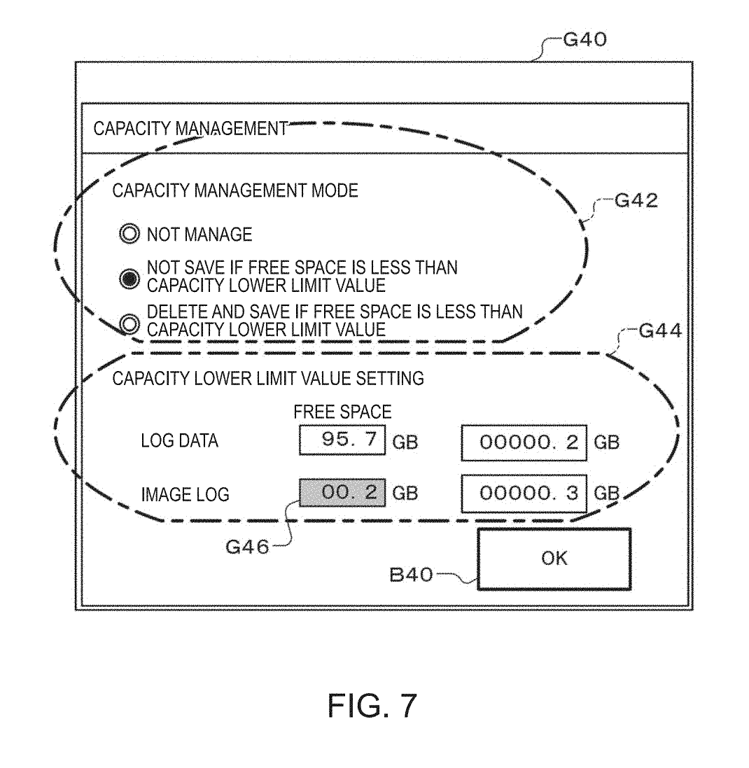

The free space notification section 30 causes the display section 16 to display an instruction that can be selected by the user. For example, the free space notification section 30 causes the display section 16 to display a capacity management screen G40 shown in FIG. 7.

The saving method instruction acceptance section 32 accepts an instruction from the user about a method for saving log data and an image log. The saving method instruction acceptance section 32 accepts, from the user, an instruction on whether to save log data and an image log in the storage section 12 or not, if the free space in the storage section 12 becomes less than a preset capacity lower limit value. The input of the instruction form the user is accepted before log data and an image log are saved in the storage section 12. Thus, the user can easily realize the saving of log data and an image log as intended. The saving method instruction acceptance section 32 saves the content of the accepted instruction in the storage section 12.

The data saving section 34 saves the log data and the image log received from the data acceptance section 26, in the storage section 12. The data saving section 34 confirms the free space via the free space detection section 28 when saving the received log data and image log. The data saving section 34 saves the log data and the image log in the storage section 12 if the free space in the storage section 12 is more than the capacity lower limit value. The data saving section 34 manages whether to save the log data and the image log in the storage section 12 or not, based on an instruction from the user, if the free space in the storage section 12 is less than the capacity lower limit value (smaller than the capacity lower limit value). After the completion of the saving operation, the data saving section 34 notifies the saving result notification section 38 of the result of the operation.

The content of the instruction from the user may be not to save log data and an image log in the storage section 12 if the free space in the storage section 12 is less than the capacity lower limit value. Thus, the user can easily realize the saving of log data and an image log as intended.

The content of the instruction from the user may be to delete the log data and the image log saved in the storage section 12 and newly save log data and an image log in the storage section 12 if the free space in the storage section 12 is less than the capacity lower limit value. Thus, the user can easily realize the saving of log data and an image log as intended.

The capacity lower limit value instruction acceptance section 36 accepts an instruction from the user about the capacity lower limit value of the free space in the storage section 12. The capacity lower limit value instruction acceptance section 36 accepts a capacity lower limit value inputted from the input section 14. The capacity lower limit value instruction acceptance section 36 saves this capacity lower limit value in the storage section 12. The capacity lower limit value instruction acceptance section 36 accepts the instruction from the user before log data and an image log are saved in the storage section 12. Thus, the user can easily realize the saving of log data and an image log as intended.

The saving result notification section 38 accepts a notification of the result of the operation of the data saving section 34. The saving result notification section 38 transmits the content of the result of the operation to the result returning section 20. The saving result notification section 38 transmits information based on the log data and the image log saved in the storage section 12, to the display section 16 and the result returning section 20.

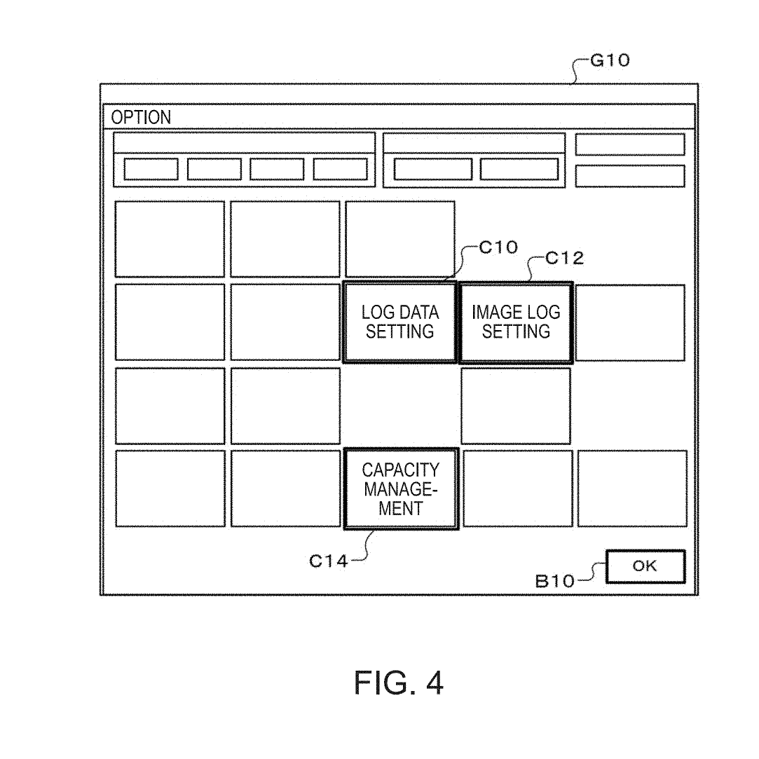

Here, an option screen G10 will be described with reference to FIG. 4.

FIG. 4 shows an example of the option screen G10. On the option screen G10, buttons respectively indicating log data setting, image log setting, and capacity management that can be selected by the user are displayed. In the example shown in FIG. 4, at least three buttons, that is, a button C10, a button C12, and a button C14, are displayed.

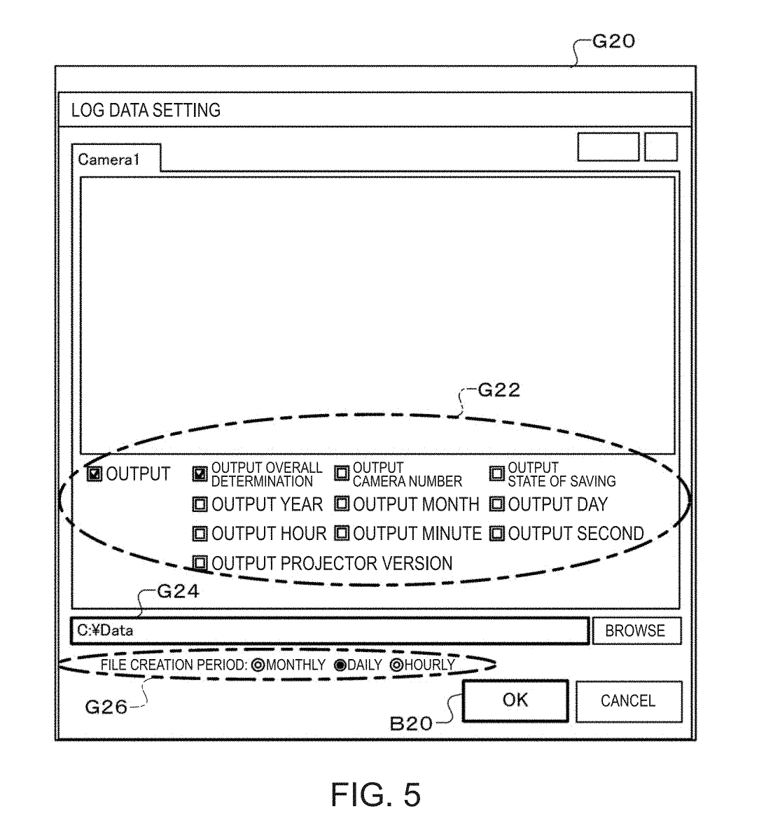

The button C10 is a button indicating log data setting. If the user carries out a selection operation (press, click, tap) on the button C10 and subsequently carries out a selection operation on a button B10, the input section 14 accepts the display of a log data setting screen G20 (see FIG. 5) corresponding to the button C10.

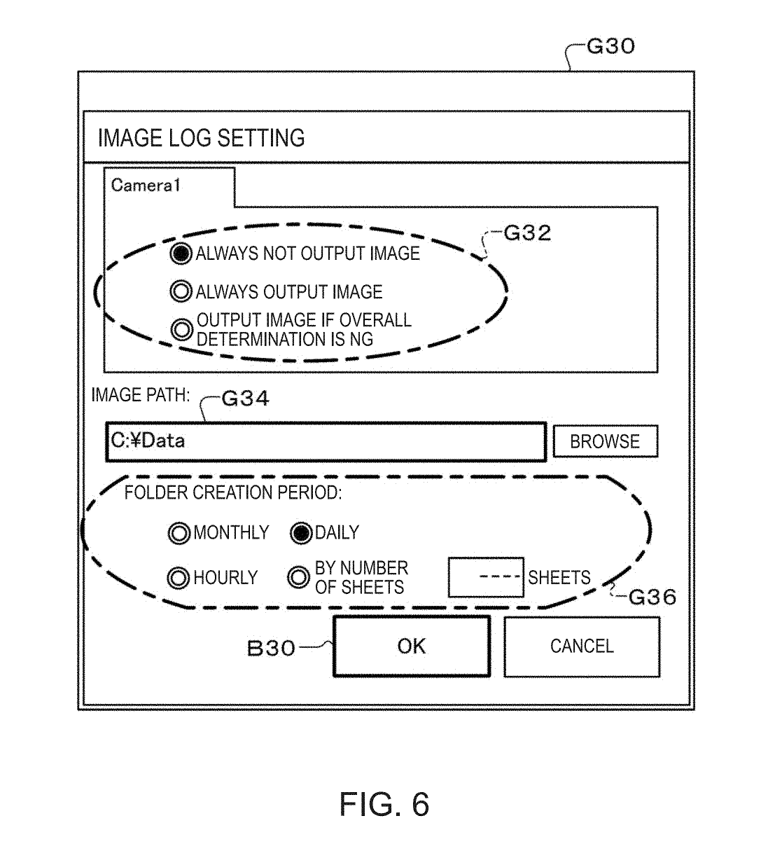

The button C12 is a button indicating image log setting. If the user carries out a selection operation on the button C12 and subsequently carries out a selection operation on the button B10, the input section 14 accepts the display of an image log setting screen G30 (see FIG. 6) corresponding to the button C12.

The button C14 is a button indicating capacity management. If the user carries out a selection operation on the button C14 and subsequently carries out a selection operation on the button B10, the input section 14 accepts the display of a capacity management screen G40 (see FIG. 7) corresponding to the button C14.

FIG. 5 shows an example of the log data setting screen G20. The log data setting screen G20 shown in FIG. 5 has an area G22, an area G24, an area G26, and a plurality of buttons including a button B20.

In the area G22, output items of log data to be selected by the user are displayed. When each item is checked, the item is outputted in log data. For example, the item “output” sets whether to output log data or not. The item “output state of saving” sets whether to output the result of the saving operation carried out this time round in the image processing device 6, or not. Specifically, “successfully saved”, “not saved”, “deleted and saved”, or “saving failed” is outputted in log data.

In the area G24, an output destination of log data is set by the user.

In the area G26, file creation period items of log data to be selected by the user are displayed.

The button B20 is a processing button to execute a sequence including one or more items displayed in the areas G22 to G26 with respect to an image to be processed by the image processing device 6.

FIG. 6 shows an example of the image log setting screen G30. The image log setting screen G30 shown in FIG. 6 has an area G32, an area G34, an area G36, and a plurality of buttons including a button B30.

In the area G32, items such as the presence or absence of output of an image log that are to be selected by the user are displayed. With these items, the frequency of output of an image log is set. If “always not output image” is selected, an image log is not outputted. If “always output image” is selected, an image log is outputted every time processing is carried out in response to an image pickup command. If “output image if overall determination is NG” is selected, an image log is outputted in the case where the overall determination is NG.

In the area G34, an output destination of an image log is set by the user.

In the area G36, folder creation period items of an image log to be selected by the user are displayed.

The button 30B is a processing button to execute a sequence including one or more items displayed in the areas G32 to G36 with respect to an image to be processed by the image processing device 6.

FIG. 7 shows an example of the capacity management screen G40. The capacity management screen G40 shown in FIG. 7 has an area G42, an area G44, and a plurality of buttons including a button B40. The capacity management screen G40 is an example of a screen for setting a capacity lower limit value of free space and an operation in the case where the free space is less than the capacity lower limit value.

A plurality of patterns may be provided for the operation in the case where the free space is less than the capacity lower limit value, thus making it easier to reflect the user's intention.

In the area G42, capacity management modes to be selected by the user are displayed. The capacity management modes include “not manage”, “not save if the free space is less than the capacity lower limit value”, and “delete and save if the free space is less than the capacity lower limit value”. In the area G42, the user selects a mode of capacity management.

In the area G44, capacity lower limit value settings to be selected by the user are displayed. The capacity lower limit value settings include free spaces for the log data and the image log. In the capacity lower limit value settings, the user can set capacity lower limit values for the log data and the image log while confirming the free spaces for the log data and the image log.

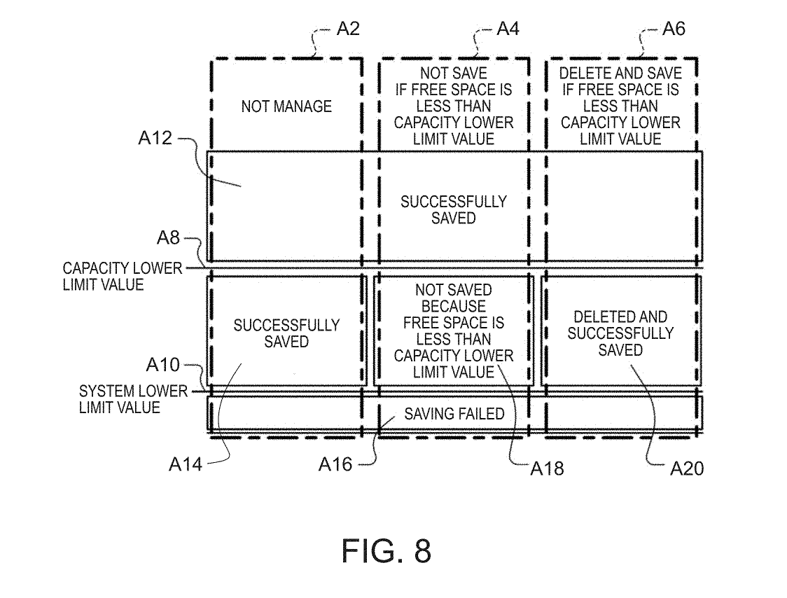

FIG. 8 shows the result of saving in the case where the free space is less than the capacity lower limit value. If the free space at the log data save location becomes less than the capacity lower limit value during continuous operation, an operation is carried out in response to an instruction set by the user, and the upper controller is notified.

In the case where the instruction from the user is “not manage” shown in an area A2, if the free space is more than a capacity lower limit value A8, a result of saving “successfully saved” is notified, as shown in an area A12. Also, if the free space is less than the capacity lower limit value A8, a result of saving “successfully saved” is notified, as shown in an area A14. Meanwhile, if the free space is less than a system lower limit value A10, a result of saving “saving failed” is notified, as shown in an area A16.

In the case where the instruction from the user is “not save if the free space is less than the capacity lower limit value” shown in an area A4, if the free space is more than the capacity lower limit value A8, a result of saving “successfully saved” is notified, as shown in the area A12. Meanwhile, if the free space is less than the capacity lower limit value A8, a result of saving “not saved because the free space is less than the capacity lower limit value” is notified, as shown in an area A18. Moreover, if the free space is less than the system lower limit value A10, a result of saving “saving failed” is notified, as shown in the area A16.

In the case where the instruction from the user is “delete and save if the free space is less than the capacity lower limit value” shown in an area A6, if the free space is more than the capacity lower limit value A8, a result of saving “successfully saved” is notified, as shown in the area A12. Meanwhile, if the free space is less than the capacity lower limit value A8, a result of saving “deleted and successfully saved” is notified, as shown in an area A20. Moreover, if the free space is less than the system lower limit value A10, a result of saving “saving failed” is notified, as shown in the area A16.

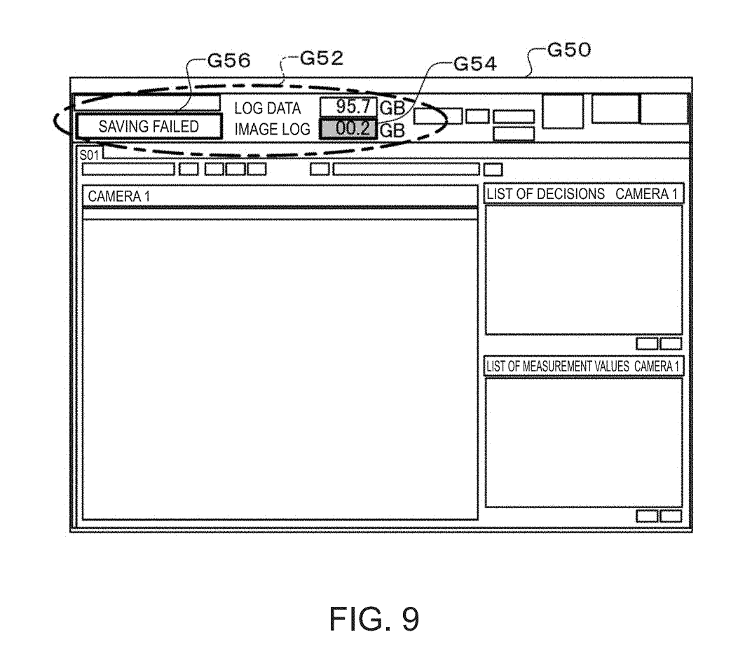

FIG. 9 shows an example of the display on a user interface (UI). A screen G50 shown in FIG. 9 has an area G52.

As shown in FIG. 9, it is possible to display the free space on the UI and also change the background color of the free space, so as to enable the user to easily grasp the free space. For example, as shown in an area G54 and an area G46 (see FIG. 7), the background may be hatched if the free space is less than the capacity lower limit value.

Also, the result of saving may be displayed as shown in an area G56.

Moreover, the free space and its state compared with the capacity lower limit value are displayed on the UI, so as to enable the user to easily confirm the free space.

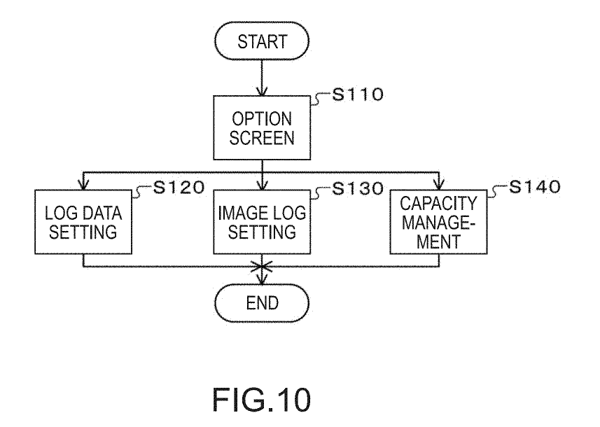

When log data setting, image log setting, and capacity management are selected by the user on such an option screen G10 and the log data setting, the image log setting, and the capacity management are executed, the image processing device 6 carries out, for example, the processing of the flowchart shown in FIG. 10.

The data management method according to the embodiment includes an input process for inputting an instruction on whether to save log data and an image log in the storage section 12 or not, if the free space in the storage section 12 is less than a preset capacity lower limit value before log data and an image log are saved in the storage section 12.

FIG. 10 is a flowchart showing an example of the flow of inputting the instruction.

The input of the instruction by the user is carried out before log data and an image log are saved in the storage section 12. In this example, the instruction on whether to save log data and an image log in the storage section 12 or not is accepted from the user if the free space is less than a preset capacity lower limit value before the data acceptance section 26 accepts log data and an image log (input process).

First in Step S110, the data management section 24 accepts an operation of pressing one of the buttons C10 to C14 and subsequently pressing the button B10 on the option screen G10, from the user via the input section 14. If the button C10 is pressed, the processing shifts to Step S120. If the button C12 is pressed, the processing shifts to Step S130. If the button C14 is pressed, the processing shifts to Step S140.

Next, in Step S120, the data management section 24 closes the option screen G10 and displays the log data setting screen G20 selected in Step S110.

Then, the data management section 24 accepts an operation of inputting the areas G22 to G26 and subsequently pressing the button B20 on the log data setting screen G20, from the user via the input section 14.

Next, in Step S130, the data management section 24 closes the option screen G10 and displays the image log setting screen G30 selected in Step S110.

Then, the data management section 24 accepts an operation of inputting the areas G32 to G36 and subsequently pressing the button B30 on the image log setting screen G30, from the user via the input section 14.

Next, in Step S140, the data management section 24 closes the option screen G10 and displays the capacity management screen G40 selected in Step S110.

If a mode that is not the ““not manage” mode is selected, a capacity lower limit value is set.

Then, the data management section 24 accepts an operation of inputting the areas G42 and G44 and subsequently pressing the button B40 on the capacity management screen G40, from the user via the input section 14.

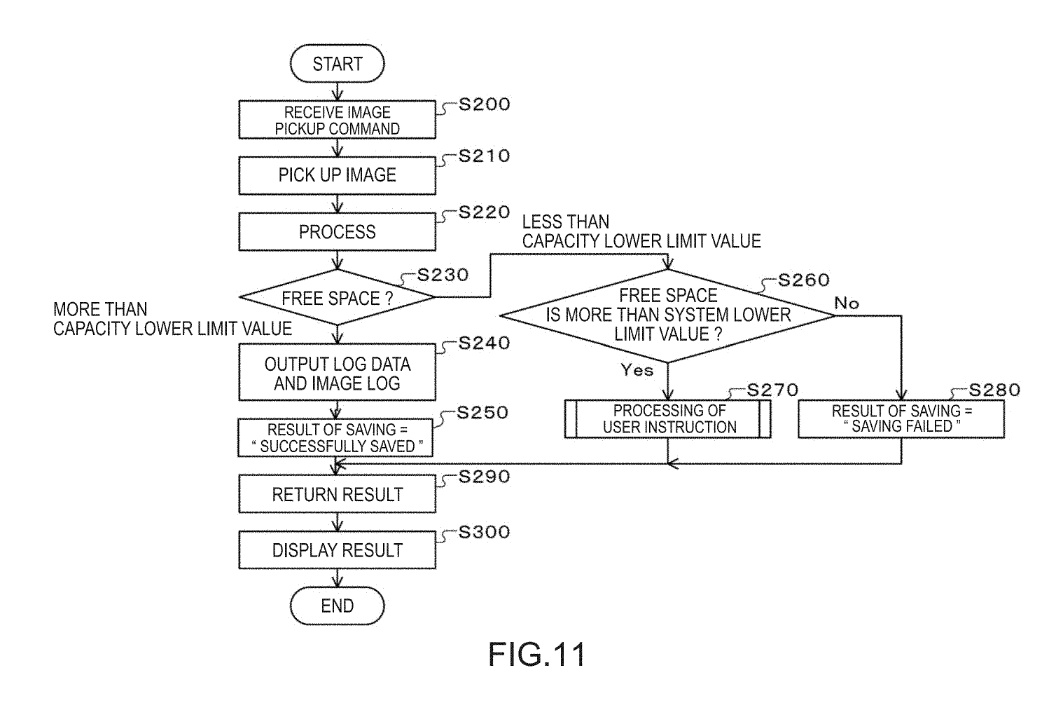

The image processing device 6 also carries out, for example, the processing of each of the flowcharts shown in FIGS. 11 to 14.

The data management method according to the embodiment includes a saving process in which log data and an image log are saved in the storage section 12, a display process in which information based on the log data and the image log saved in the storage section 12 is displayed, and a data management process in which whether to save log data and an image log in the storage section 12 or not is managed based on an instruction.

Hereinafter, the data management method will be described with reference to FIG. 11.

FIG. 11 is a flowchart showing an example of the data management method.

First, in Step S200, the communication section 18 receives an image pickup command from the upper controller.

Next, in Step S210, the data management section 24 causes the image pickup unit 8 to pick up an image.

Next, in Step S220, the image processing section 22 carries out image processing. Specifically, the image processing section 22 acquires, from the image pickup unit 8, the picked-up image picked up by the image pickup unit 8. The data management section 24 performs processing such as inspection and measurement on an object (for example, the object O shown in FIG. 1) included in the acquired image. The image processing section 22 generates log data and an image log according to the state of the image processing device 6.

Next, in Step S230, the free space detection section 28 confirms the free space in the storage section 12. The data management section 24 confirms whether the free space is less than the capacity lower limit value or more than the capacity lower limit value. If the free space is less than the capacity lower limit value, the processing shifts to Step S260. If the free space is more than the capacity lower limit value, the processing shifts to Step S240.

Next, in Step S240, the data saving section 34 saves the log data and the image log in the storage section 12 (saving process).

Next, in Step S250, the data management section 24 sets “successfully saved” as the result of saving.

Next, in Step S260, the data management section 24 confirms whether the free space is more than the system lower limit value or not. If Yes, the processing shifts to Step S270. If No, the processing shifts to Step S280.

Next, in Step S270, the data saving section 34 carries out “processing of a user instruction”. If the free space is less than the capacity lower limit value, the “processing of user instruction” is carried out (data management process).

The “processing of user instruction” is divided into three patterns according to user settings. The data saving section 34 outputs the log data and the image log if it is confirmed by the free space detection section 28 that the free space in the storage section 12 is more than the capacity lower limit value.

Next, in Step S280, the data management section 24 sets “saving failed” as the result of saving.

Next, in Step S290, the result returning section 20 returns the result to the upper controller.

Next, in Step S300, the saving result notification section 38 displays the result on the screen (display process). The processing thus ends.

### Processing of User Instruction

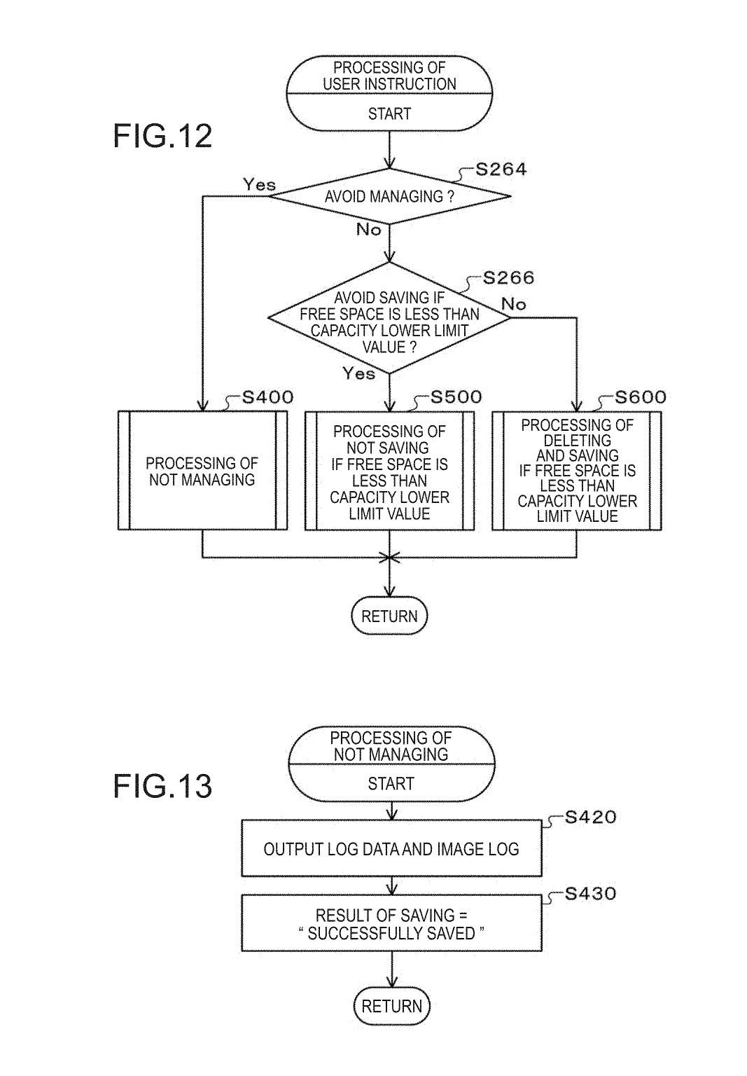

FIG. 12 will now be described.

FIG. 12 is a flowchart showing an example of the flow of the “processing of user instruction”. The flow below explains in detail the “processing of user instruction” in Step S270 shown in FIG. 11. This flow is executed as a subroutine program (not illustrated) stored in the storage section 12 is called from a control program.

First, in Step S264, the data management section 24 confirms whether to avoid managing or not. If Yes, the processing shifts to Step S400. If No, the processing shifts to Step S266.

Next, in Step S266, the data management section 24 confirms whether to avoid saving because the free space is less than the capacity lower limit value, or not. If Yes, the processing shifts to Step S500. If No, the processing shifts to Step S600.

In Step S400, the data management section 24 executes “processing of not managing”.

In Step S500, the data management section 24 executes “processing of not saving if the free space is less than the capacity lower limit value”.

In Step S600, the data management section 24 executes “processing of deleting and saving if the free space is less than the capacity lower limit value”.

### Processing of not Managing

FIG. 13 will now be described.

FIG. 13 is a flowchart showing an example of the flow of the “processing of not managing”. The flow below explains in detail the “processing of not managing” in Step S400 shown in FIG. 12. This flow is executed as a subroutine program (not illustrated) stored in the storage section 12 is called from the control program.

First, in Step S420, the data saving section 34 saves the log data and the image log in the storage section 12 (saving process).

Next, in Step S430, the data management section 24 sets “successfully saved” as the result of saving. The processing then returns to Step S290.

Processing of not Saving if Free Space is Less than Capacity Lower Limit Value

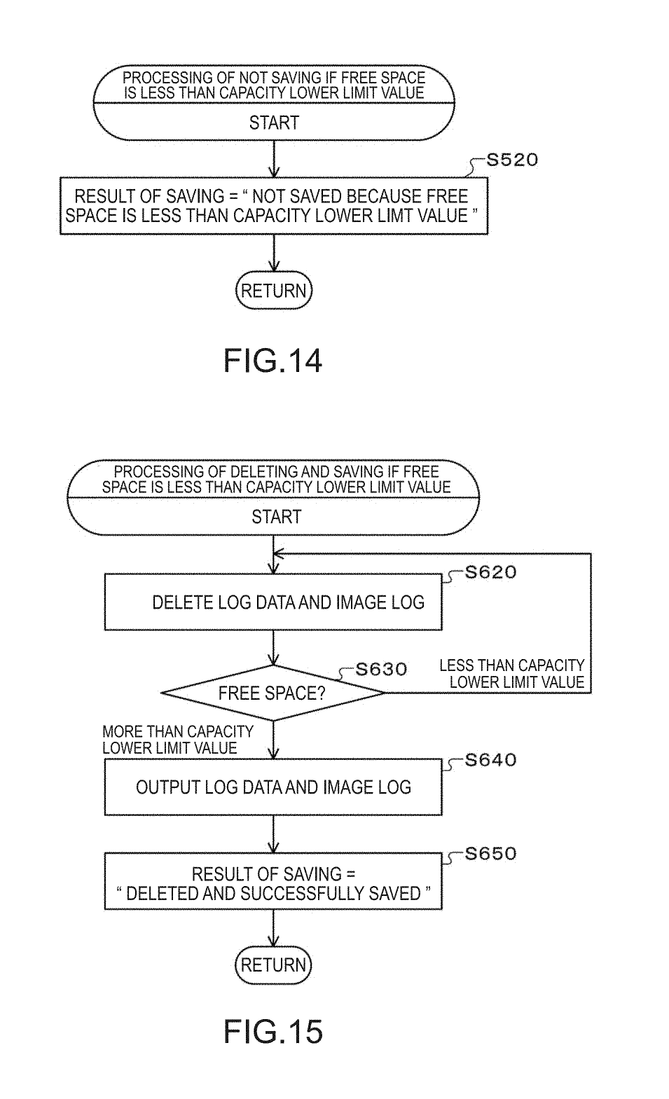

FIG. 14 will now be described.

FIG. 14 is a flowchart showing an example of the flow of the “processing of not saving if the free space is less than the capacity lower limit value”. The flow below explains in detail the ““processing of not saving if the free space is less than the capacity lower limit value” in Step S500 shown in FIG. 12. This flow is executed as a subroutine program (not illustrated) stored in the storage section 12 is called from the control program.

First, in Step S520, the data management section 24 sets “not saved because the free space is less than the capacity lower limit value” as the result of saving. The processing then returns to Step S290.

Processing of Deleting and Saving if Free Space is Less than Capacity Lower Limit Value

FIG. 15 will now be described.

FIG. 15 is a flowchart showing an example of the flow of the “processing of deleting and saving if the free space is less than the capacity lower limit value”. The flow below explains in detail the “processing of deleting and saving if the free space is less than the capacity lower limit value” in Step S600 shown in FIG. 12. This flow is executed as a subroutine program (not illustrated) stored in the storage section 12 is called from the control program.

First, in Step S620, the log data and the image log are deleted. The deletion is carried out on a file basis for the log data and on a folder basis for the image log. The log data and the image log may be deleted in order from the oldest. For example, those past a log data retention period of 90 days may be deleted in order from the oldest. Also, the log data and the image log may be automatically saved in backup. Moreover, the retention period for the log data and the image log may be decided in advance.

Next, in Step S630, the free space detection section 28 confirms the free space in the storage section 12. The data management section 24 confirms whether the free space is less than the capacity lower limit value or more than the capacity lower limit value. If the free space is less than the capacity lower limit value, the processing returns to Step S620. If the free space is more than the capacity lower limit value, the processing shifts to Step S640.

Next, in Step S640, the data saving section 34 saves the log data and the image log in the storage section 12 (saving process).

Next, in Step S650, the data management section 24 sets “deleted and successfully saved” as the result of saving. The processing then returns to Step S290.

Issue Warning if Free Space is Less than Capacity Lower Limit Value

Also, a warning may be issued if the free space is less than the capacity lower limit value. Specifically, “less than the capacity lower limit value” may be set as the result of saving, and if the free space is less than the capacity lower limit value, a warning that indicates the result of saving “less than the capacity lower limit value” may be notified to the outside.

Also, the processing in the embodiment may be realized by software. The software may be distributed by software download or the like. Alternatively, the software may be recorded on a CD-ROM or the like and distributed in this form. This also applies the other embodiments in this description. The software realizing the image processing device 6 in this embodiment is a program as described below. That is, this program is recorded on a computer-accessible recording medium and causes a computer to function as: the data acceptance section 26, which accepts data; the free space detection section 28, which detects the free space in the storage section 12; the free space notification section 30, which causes the display section 16 to display an instruction that can be selected by the user; and the saving method instruction acceptance section 32, which accepts, from the user, an instruction on whether to save log data and image log in the storage section 12 or not if the free space in the storage section 12 is less than a preset capacity lower limit value before data is saved in the storage section 12.

### Configuration of Robot System

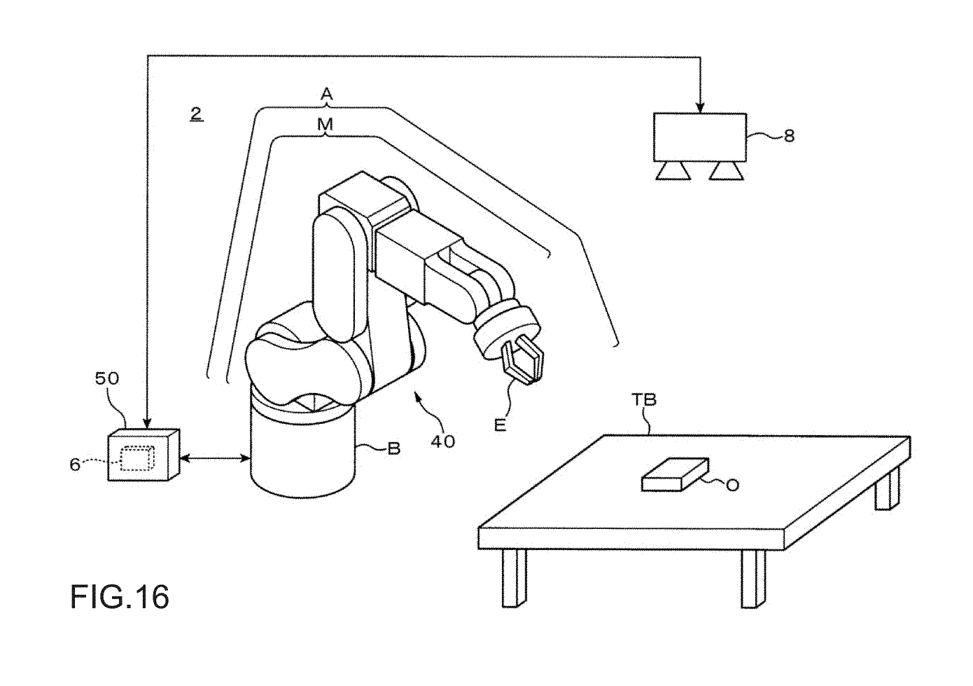

Hereinafter, the configuration of a robot system 2 will be described with reference to FIG. 16. Components similar to those of the embodiment described above are denoted by the same reference signs and will not be described further in detail.

FIG. 16 shows an example of the configuration of the robot system 2 according to this embodiment. The robot system 2 has the image pickup unit 8, a robot 40, and a robot control device 50. The robot control device 50 has the image processing device 6. More specifically, the robot control device 50 has each functional section of the image processing device 6.

The robot 40 is a single-arm robot having an arm A and a support base B. A single-arm robot is a robot having one arm such as the arm A in this example. The robot 40 may be a multi-arm robot instead of the single-arm robot. A multi-arm robot is a robot having two or more arms (for example, two or more arms A). Of multi-arm robots, a robot having two arms is referred to as a dual-arm robot. That is, the robot 40 may be a dual-arm robot having two arms or may be a multi-arm robot having three or more arms (for example, three or more arms A). Also, the robot 40 may be other types of robots such as a SCARA robot or cylindrical robot.

The arm A has an end effector E and a manipulator M.

The end effector E in this example is an end effector having a finger part capable of gripping an object. The end effector E may also be an end effector capable of lifting up an object by air suction, magnetic force, jig or the like, or other types of end effectors, instead of the end effector having the finger part.

The end effector E is connected to the robot control device 50 via a cable in such a way as to be able to communicate. Thus, the end effector E carries out an operation based on a control signal acquired from the robot control device 50. The wired communication via the cable is carried out, for example, according to a standard such as Ethernet (trademark registered) or USB. The end effector E may be configured to be connected to the robot control device 50 via wireless communication carried out according to a communication standard such as Wi-Fi (trademark registered).

The manipulator M has six joints. Each of the six joints has an actuator, not illustrated. That is, the arm A having the manipulator M is a six-axis vertical multi-joint arm. The arm A carries out operations with six-axis degrees of freedom based on linked movements of the support base B, the end effector E, the manipulator M, and the respective actuators of the six joints of the manipulator M. The arm A may also be configured to operate with five-axis or fewer degrees of freedom, or may be configured to operate with seven-axis or more degrees of freedom.

Each of the six actuators (provided for the joints) of the manipulator M is connected to the robot control device 50 via a cable in such a way as to be able to communicate. Thus, the actuators cause the manipulator M to operate, based on a control signal acquired from the robot control device 50. The wired communication via the cable is carried out, for example, according to a standard such as Ethernet (trademark registered) or USB. A part or all of the six actuators provided for the manipulator M may be configured to be connected to the robot control device 50 via wireless communication carried out according to a communication standard such as Wi-Fi (trademark registered).

The robot control device 50 in this example is a device which controls the robot. The robot control device 50 generates a control signal based on an operation program inputted in advance. The robot control device 50 transmits the generated control signal to the robot 40 and causes the robot 40 to carry out predetermined work. The predetermined work in this example is to cause the robot 40 to move the arm A and to grip the object O placed on the top surface of the workbench TB and arrange the gripped object O in a material feed area, not illustrated. The predetermined work may be other kinds of work instead of this.

When causing the robot 40 to carry out the predetermined work, the robot control device 50 causes the image pickup unit 8 to pick up an image over a range including the object O. The robot control device 50 acquires, from the image pickup unit 8, the picked-up image picked up by the image pickup unit 8. Then, the robot control device 50 creates a sequence using both two-dimensional processing and three-dimensional processing and executes the sequence on the acquired picked-up image. Thus, the robot control device 50 calculates the position and attitude of the object O. The robot control device 50 causes the robot 40 to carry out the predetermined work, based on the calculated position and attitude.

That is, the robot control device 50 has the image processing device 6 described in the embodiment and causes the image processing device 6 to calculate the position and attitude of the object O, based on the sequence using both two-dimensional processing and three-dimensional processing created by the image processing device 6.

In the robot system 2, the robot control device 50 and the image processing device 6 may be separate units. In this case, the robot control device 50 acquires, from the image processing device 6, the position and attitude of the object O calculated by the image processing device 6, and causes the robot 40 to carry out the predetermined work, based on the acquired position and attitude.

According to this embodiment, whether to save data in the storage unit or not is managed based on an instruction from the user. Therefore, the saving of log data and an image log as intended by the user can be realized while the risk of operation stoppage of the device is reduced. Thus, the stoppage of the device caused by saving failure of log data and an image log due to a shortage of capacity can be avoided. As a result, an image processing device, a data management method, a program, and a robot system that maintain continuous operation can be provided.

The embodiment of the invention has been described in detail with reference to the drawings. However, the specific configuration in this embodiment is not limiting. Change, replacement, deletion or the like can be made without departing from the scope of the invention.

A program for realizing the function of an arbitrary component in the devices described above (for example, image processing device 6, robot control device 50) may be saved in a computer-readable recording medium, and a computer system may be caused to read and execute this program. The “computer system” in this case includes an OS (operating system) and hardware such as peripheral devices. The “computer-readable recording medium” refers to a portable medium such as a flexible disk, magneto-optical disk, ROM, or CD (compact disk)-ROM, or a storage device such as a hard disk built in the computer system. The “computer-readable recording medium” also includes a recording medium which holds the program for a predetermined period of time, such as a volatile memory (RAM) inside a computer system that serves as a server or a client when the program is transmitted via a network such as the internet or via a communication channel such as a telephone line.

The program may be transmitted from the computer system having the program stored in a storage device or the like, to another computer via a transmission medium or via transmission waves in a transmission medium. Here, the “transmission medium” transmitting the program refers to a medium having the function of transmitting information like a network (communication network) such as the internet, or a communication channel (communication line) such as a telephone line.

The program may be for realizing a part of the functions described above. Also, the program may be a so-called differential file (differential program), which can realize the functions in combination with a program already saved in the computer system.

In the embodiment, the first surface, which is a flat surface (plane) where the robot (base) is fixed, is a flat surface (plane) parallel to the horizontal plane. However, the invention is not limited to this. For example, a flat surface (plane) tilted from the horizontal plane or the vertical plane may be used. Also, a flat surface (plane) parallel to the vertical plane may be used. That is, the axis of rotation may be tilted from the vertical direction or the horizontal direction, or may be parallel to the horizontal direction.

The robot according to the invention is not limited to the vertical multi-joint robot. Similar effects can be achieved with a horizontal multi-joint robot, parallel-link robot, dual-arm robot or the like. Moreover, the robot according to the invention is not limited to the six-axis robot. Similar effects can be achieved with a robot with seven or more axes, and a robot with five or fewer axes. The robot according to the embodiment is not limited to the arm-type robot (robot arm), provided that the robot has an arm. Other forms of robots, for example, a legged walking (running) robot or the like, may be employed.

The entire disclosure of Japanese Patent Application No. 2016-232188, filed Nov. 30, 2016 is expressly incorporated by reference herein.

What is claimed is:

1. A data management device comprising:
a storage unit which saves data;
a display unit which displays information based on data saved in the storage unit;
an input unit for inputting an instruction on whether to save data in the storage unit or not, if a free space in the storage unit is less than a preset capacity lower limit value before data is saved in the storage unit; and
a data management unit which manages whether to save data in the storage unit or not, based on the instruction.

2. The data management device according to claim 1, wherein
the instruction is not to save data in the storage unit if the free space is less than the capacity lower limit value.

3. The data management device according to claim 1, wherein
the instruction is to save data in the storage unit after data saved in the storage unit is deleted if the free space is less than the capacity lower limit value.

4. The data management device according to claim 1, wherein
the data management unit comprises:
a data acceptance unit which accepts data;
a free space detection unit which detects the free space in the storage unit;
a free space notification unit which causes the display unit to display an instruction that can be selected by a user; and
a saving method instruction acceptance unit which accepts, from the user, an instruction on whether to save data in the storage unit or not, if the free space in the storage unit is less than a preset capacity lower limit value before data is saved in the storage unit.

5. The data management device according to claim 4, wherein
the data management unit comprises
a capacity lower limit value instruction acceptance unit which accepts the capacity lower limit value before data is saved in the storage unit.

6. A data management method comprising:
saving data in a storage unit;
displaying information based on data saved in the storage unit;
inputting an instruction on whether to save data in the storage unit or not, if a free space in the storage unit is less than a preset capacity lower limit value before data is saved in the storage unit; and
managing whether to save data in the storage unit or not, based on the instruction.
